(19) United States
(12) Patent Application Publication
(10) Pub. No.: US 2009/0120101 A1
(43) Pub. Date: May 14, 2009

(54) Organic Matrix Composite Components, Systems Using Such Components, and Methods for Manufacturing Such Components

(75) Inventors: Gary M. Lomasney, Glastonbury, CT (US); Joseph Parkos, JR., East Haddam, CT (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: UNITED TECHNOLOGIES CORP., Hartford, CT (US)

(21) Appl. No.: 11/931,318

(22) Filed: Oct. 31, 2007

(51) Int. Cl. F02C 7/20; B32B 15/04; B05D 1/00

(52) U.S. Cl. 60/796; 428/457; 428/472; 427/404; 427/531; 427/530

(57) ABSTRACT

Organic matrix composite components, systems using such components, and methods for manufacturing such components are provided. In this regard, a representative organic matrix composite component includes: an organic matrix composite; a layer of aluminum applied to the organic matrix composite; and a wear resistant coating applied to the aluminum layer.

### BACKGROUND

1. Technical Field

The disclosure generally relates to manufacture and use of organic matrix composites.

2. Description of the Related Art

Organic matrix composites have been used in a variety of applications in which high strength and reduced weight is desired. However, organic matrix composites typically exhibit susceptibility to thermal damage and erosive wear. Because of these characteristics, organic matrix composites oftentimes are shielded from high temperatures and erosive environments. By way of example, metal pre-forms have been used that are shaped to conform to the exterior surfaces of organic matrix composite structures, with the pre-forms being glued to the exterior surfaces.

### SUMMARY

Organic matrix composite components, systems using such components, and methods for manufacturing such components are provided. In this regard, an exemplary embodiment of an organic matrix composite component comprises: an organic matrix composite; a layer of aluminum applied to the organic matrix composite; and a wear resistant coating applied to the aluminum layer.

An exemplary embodiment of a method for forming an organic matrix composite component comprises: providing a substrate of organic matrix composite; applying a metal layer to the organic matrix composite; and applying a coating to surround at least a portion of the metal layer and at least a portion of the organic matrix composite.

An exemplary embodiment of a gas turbine engine comprises: a component comprising: an organic matrix composite; a layer of aluminum located adjacent to and contacting the organic matrix composite; and a wear resistant coating located adjacent to and contacting the aluminum layer.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 is a schematic diagram depicting an exemplary embodiment of a gas turbine engine.

FIG. 2 is a schematic diagram depicting a portion of a component and representative material layers forming the component.

FIG. 3 is a flowchart depicting an exemplary embodiment of a method for forming a component.

FIG. 4 is a schematic diagram depicting a portion of a component and representative material layers forming the component.

### DETAILED DESCRIPTION

Organic matrix composite components and methods for manufacturing such components are provided, several exemplary embodiments of which will be described in detail. In this regard, some embodiments involve the use of a metal layer (e.g., aluminum) that is applied to the exterior surface of an organic matrix composite. A coating (e.g., a coating comprising titanium oxide) is applied to the metal. As such, the coating provides wear resistance to the underlying organic matrix composite.

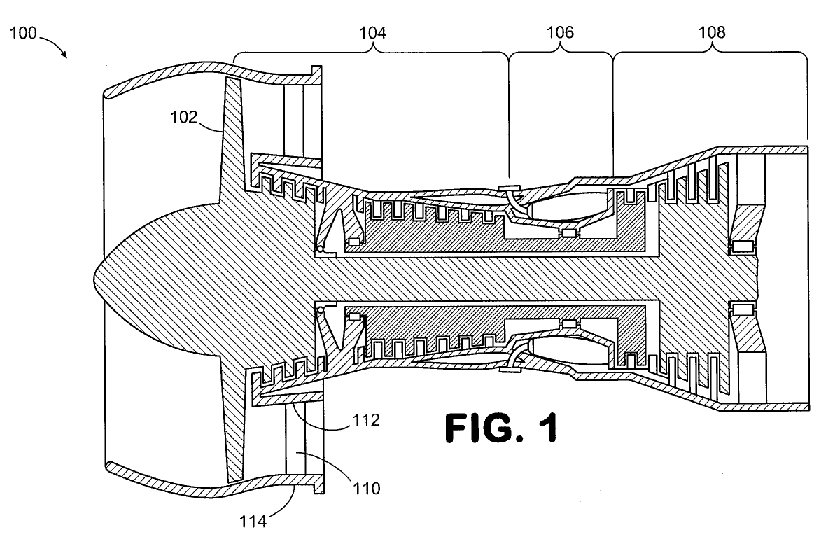

FIG. 1 is a schematic diagram depicting an exemplary embodiment of a gas turbine engine. As shown in FIG. 1, engine 100 is configured as a turbofan gas turbine engine that incorporates a fan 102, a compressor section 104, a combustion section 106 and a turbine section 108. Although configured as a turbofan, there is no intention to limit the concepts described herein to use with turbofans as use with other types of gas turbine engines and other applications that may not involve gas turbine engines are contemplated.

Organic matrix composite components (i.e., components that incorporate organic matrix composite materials) may be suited for use in various portions of engine 100, such as in a cold section. By way of example, struts (e.g., strut 110) extend across a fan duct between an inner shroud 112 and an outer shroud 114. Such struts typically are exposed to high velocity air and, therefore, tend to exhibit erosive wear on outer surfaces of the struts.

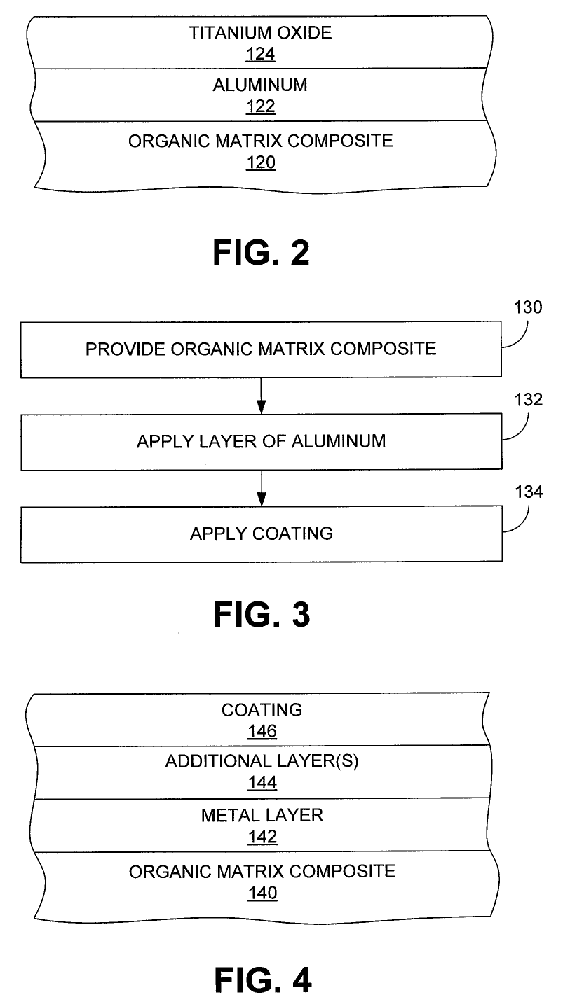

In this regard, a portion of strut 110 is depicted schematically in FIG. 2. As shown in FIG. 2, an inner, structural portion 120 of the strut is formed of an organic matrix composite. Such an organic matrix composite comprises high tensile strength fibers and a matrix material for binding the fibers. By way of example, the fibers can include carbon fibers, aramid fibers and glass fibers, whereas the matrix can comprise epoxy and polyamide resins. Notably, the fibers can be oriented as desired to provide desired load characteristics.

A layer of aluminum 122 is applied to an exterior surface of the organic matrix composite. In this regard, the aluminum can be applied by one or more of various processes such as Ion Vapor Deposition (IVD). In other embodiments, various other methods may be used such as Cold Spray, Cathodic Arc, or Chemical Vapor Deposition (CVD). The thickness of the aluminum may be determined, at least in part, on the needs of the coating method selected to follow the aluminum.

In this regard, a coating of titanium oxide 124 is applied to an exterior of the aluminum layer. In some embodiments, the titanium oxide is applied using an Alodine® EC2™ process (available from Henkel KGAA of Germany) which provides a flexible, wear resistant and corrosion resistant coating to the surface of the aluminum and the underlying organic matrix composite. Notably, this is in contrast to adhering a metallic pre-form to an exterior of the organic matrix composite. It should also be noted that the Alodine® EC2™ process is capable of generating other oxide coatings that may be useful.

The thickness of such a coating may vary depending on the erosion requirement and hardness of the coating. Notably, the Alodine® EC2™ process is capable of forming coatings of between approximately 10 and approximately 15 microns. However, there is no intention to limit the concept to this particular thickness range. Additionally, since such a coating provides a stable substrate, other coatings can be applied thereto. By way of example, a plasma spray coating can be applied which is not considered amenable to direct coating on an organic matrix composite.

Use of a metallic substrate (e.g., aluminum) applied to an organic matrix composite may also allow metallic coatings to be used. In particular, one or more metallic coatings can be applied to the metallic substrate through various methods such as plating. Notably, part configuration (e.g., limited area) may influence which method of applying such a metallic coating would be appropriate.

In some embodiments, a metallic coating may be provided by electrolytically interacting with the metal layer. For instance, an aluminum coating can be used to generate a hard alumina coating through a hardcoating process. In some embodiments, approximately 1 mil of the coating is used to generate 2 mils of alumina. Other methods, such as alkaline hardcoating methods (e.g., CeraFuse™ or Keronite™ processes), also can be used.

An exemplary embodiment of a method for manufacturing an organic matrix composite component is depicted in the flowchart of FIG. 3. As shown in FIG. 3, the method may be construed as beginning at block 130, in which an organic matrix composite is provided. In block 132, a layer of aluminum is applied. By way of example, the aluminum can be applied by IVD. Thereafter, such as depicted in block 134, a coating is applied. For instance, the coating can be a wear resistant coating, such as an electroceramic coating of titanium oxide that is applied to the aluminum layer.

FIG. 4 is a schematic diagram depicting another exemplary embodiment of a component that is formed of an organic matrix composite material. As shown in FIG. 4, organic matrix composite 140 is coated with a layer 142 of metal, e.g., aluminum. Once the organic matrix has a metallic coating, one or more additional coatings can be applied to provide the desired erosion protection. Thus, one of more additional (optional) layers, such as metallic layers 144, are applied to an exterior surface of the aluminum. Thereafter, a wear resistant coating 146, e.g., titanium oxide, is applied. Notably, the wear resistant coating may be a stand-alone coating or supplemented by one or more additional layers. Typical operating temperature limits for components formed in the aforementioned manner may be approximately 250° F. (121.1° C.), however, temperature limits of up to approximately 500° F. (260° C.) or more may be exhibited in other embodiments.

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. All such modifications and variations are intended to be included herein within the scope of this disclosure and protected by the accompanying claims.

1. An organic matrix composite component comprising:
an organic matrix composite;
a layer of aluminum applied to the organic matrix composite; and
a wear resistant coating applied to the aluminum layer.

2. The component of claim 1, wherein the wear resistant coating comprises titanium oxide.

3. The component of claim 1, wherein the component is a gas turbine engine component.

4. The component of claim 3, wherein the component is a cold section component of the gas turbine engine.

5. The component of claim 4, wherein the component is a strut.

6. The component of claim 1, wherein the aluminum directly contacts the organic matrix composite without an intervening layer of adhesive being disposed therebetween.

7. A method for forming an organic matrix composite component comprising:
providing a substrate of organic matrix composite;
applying a metal layer to the organic matrix composite; and
applying a coating to surround at least a portion of the metal layer and at least a portion of the organic matrix composite.

8. The method of claim 7, wherein the metal is aluminum.

9. The method of claim 8, wherein the aluminum is applied directly to the organic matrix composite.

10. The method of claim 7, wherein applying the metal layer comprises applying the metal layer using Ion Vapor Deposition.

11. The method of claim 7, wherein the coating is a wear resistant coating applied directly to the metal layer.

12. The method of claim 7, further comprising applying at least a second metal layer between the metal layer and the coating.

13. The method of claim 7, wherein the coating comprises titanium oxide.

14. The method of claim 13, wherein the coating is applied using an Alodine® EC2™ process.

15. The method of claim 7, wherein the coating exhibits a thickness of between approximately 10 microns and approximately 15 microns.

16. A gas turbine engine comprising:
a component comprising: an organic matrix composite; a layer of aluminum located adjacent to and contacting the organic matrix composite; and a wear resistant coating located adjacent to and contacting the aluminum layer.

17. The engine of claim 16, wherein the component is a cold section component.

18. The engine of claim 17, wherein the coating comprises titanium oxide.

19. The engine of claim 16, wherein the component is a strut.

20. The engine of claim 16, wherein the engine is a turbofan engine.
